(19) United States
(12) Patent Application Publication
(10) Pub. No.: US 2014/0332330 A1
(43) Pub. Date: Nov. 13, 2014

(54) Method Of Coating Rotors And Rotors

(71) Applicant: BASF Coatings GmbH, Münster (DE)

(72) Inventors: Charles P. Orr, Warren, MI (US); Patrick L. Fox, Mancelona, MI (US)

(21) Appl. No.: 14/363,684

(22) PCT Filed: Nov. 16, 2012
(86) PCT No.: PCT/US2012/065583

§ 371 Date: Jun. 6, 2014

Related U.S. Application Data
(60) Provisional application No. 61/568,925, filed on Dec. 9, 2011.

(51) Int. Cl. F16D 65/12; C25D 7/00

(52) U.S. Cl. CPC F16D 65/127; C25D 7/00
USPC 188/218 XL; 205/209

(57) ABSTRACT

A treated rotor is provided by a method in which a surface of a ferrous rotor having cooling elements is heat-treated to produce a microporous, outermost surface layer, then the heat-treated rotor is coated by electrodepositing a coating layer of an electrocoat coating composition on the heat-treated the surface of to provide a electrocoat coating directed on the surface of the heat-treated rotor. The electrocoat coating layer has a throwpower of at least about 40% and the coating layer is continuous on cooling elements of the rotor. The microporous outermost layer is a controlled iron oxide layer.

### FIELD OF THE DISCLOSURE

This invention is in the fields of methods for corrosion protection of metal articles, of electrocoat (electrodeposition) coating methods, and the coated substrates made by such methods

### BACKGROUND

The statements in this section merely provide background information related to this disclosure and may not constitute prior art.

One type of braking system used in motor vehicles, a disc brake, presses brake pads against inboard and outboard braking surfaces that constitute either surface of a disc of a cast iron rotor mounted on the wheel hub. In some designs the rotor and the hub may be one piece. When a vehicle is driven regularly, the friction from pressing the pads against the rotor's braking surfaces during braking removes any corrosion (rust) that may form. However, there is typically a period of time after its manufacture when a vehicle is awaiting sale at a dealership and is not driven or is driven only infrequently and for only short distances. During this time rust can build up on the brake rotors. This condition is known in the industry as “lot rot” and is recognized as a serious problem. Corrosion on the braking surfaces themselves produces a thickness variation between corroded areas exposed to outdoor conditions and non-corroded areas that have been covered under the brake pads located inside the caliper and so have been protected from the outdoor exposure. This thickness variation from uneven corrosion can cause uneven braking (brake “pulsation”) and brake noise. Another problem that may occur with this is in connection with the rotor's cooling elements, such as fins extending from the disc's inner circumference, interior channels through the disc, and cross-drilled ventilation holes through the disc. These elements help dissipate heat built up during braking. Corrosion debris blocks these cooling elements, interfering with their cooling function. Then, heat buildup during braking increases braking surface wear and brake pad wear and may cause the braking surface to wear unevenly. Still further, corrosion can cause anti-lock braking system (ABS) sensors to malfunction. An ABS sensor floating over a ring of teeth around the disc's inner circumference signals an onboard computer to adjust braking pressure when a significant difference in wheel rotation is detected compared to the other wheels. If the teeth become corroded, the sensor may be unable to properly monitor wheel rotation, sending a false signal and causing serious braking problems.

Attempts to address the problem by applying an air-dry coating have been unsatisfactory. The air-dry coating is quickly worn off of the disc surfaces, even before the vehicle arrives at the dealership. Additionally, the air-dry coating does not penetrate the rotor's interior disc channels, providing no corrosion protection for these critical cooling elements against road salt and water thrown up by the tires.

### SUMMARY

This disclosure provides a method of making a ferrous rotor, such as an automotive vehicle brake rotor, that includes heat-treating the rotor to provide a surface having a three-layer structure of a microporous outermost surface layer of a controlled iron oxide. The outermost surface layer is chemically bonded to an intermediate surface layer of a microporous, ferritic nitrocarburized iron epsilon layer that in turn overlies an innermost nitride layer. The outermost surface layer has a porosity of from about 40% to about 60% by volume. The method further includes applying an electrocoat coating layer directly onto the surface of the heat-treated rotor by immersing the rotor in an electrocoat coating composition containing an aqueous dispersion of a binder, with the rotor being connected as a cathode in a electrical cell, and passing current between the rotor and an anode to electrodeposit a coating layer onto the surface, then curing the electrodeposited coating layer. The binder comprises an acid-salted, amine-functional epoxy resin and a blocked isocyanate crosslinker. The electrocoat coating composition has a throwpower of at least about 40% as measured by the four-panel box throwpower test. Cooling elements, such as cooling channels or holes through the disc or cooling fins, are provided with a continuous layer of the electrocoat coating. Other elements, such as teeth of an ABS ring molded into the rotor, are also protected from corrosion by the treatment and coating. The rotor may be a one-piece construction including a wheel hub component.

This disclosure also describes a similar method of making a rotor, wherein the ferrous rotor is heat-treated as described, then an electrocoat coating is applied directly onto the surface of the heat-treated rotor from an electrocoat coating composition and the applied coating is cured, in which the binder comprises an amine-functional epoxy resin that is the reaction product of a polyepoxide having an epoxide equivalent weight (“EEW”) of from about 450 to about 1000 grams/equivalent (“g/eq”) and an amine having at least one group reactive with an epoxide group, wherein the amine groups of the amine-functional epoxy resin are neutralized with an acid to an extent such that the amine-functional epoxy resin is made water-dispersible.

Rotors produced by these methods are also provided by the invention. The electrocoat coating has unexpectedly excellent adhesion to the surface of the heat-treated rotor. The method saves significant material and equipment costs over a method of phosphating the rotor surface before applying an electrocoat layer. It was unexpected and could not have been foreseen that the method would provide a sufficient adhesion of the electrocoat layer to the unphosphated rotor surface and a sufficient corrosion protection to the rotor to overcome the problems of corrosion and overheating, such as those described above. Further, the electrocoat coating composition having the disclosed throwpower not only coats the outer surfaces of the rotor, but also coats and protects the interior surfaces of cooling channels through the rotor disc to provide protection of those channels from corrosion, which earlier methods were unable to provide.

In describing the invention, certain terms and descriptions are used and interpreted as follow. “Binder” refers to the film-forming components of a coating composition. “Polymer” and “resin” are used interchangeably in this disclosure. “Epoxy resin” is used to refer to either aromatic or aliphatic resins prepared by ring-opening polymerization of epoxide (oxirane) rings. “A” and “an” as used herein indicate “at least one” of the item is present; a plurality of such items may be present, when possible. Throughout this disclosure, the numerical values represent approximate measures or limits to ranges to encompass minor deviations from the given values and embodiments having about the value mentioned as well as those having exactly the value mentioned. Other than in the working examples provides at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and subdivided ranges within the entire range.

### DRAWINGS

The drawings described in this disclosure are for illustrative purposes only of selected embodiments and not all possible implementations. The drawing are not intended to limit the scope of the present disclosure.

FIG. 1A is a perspective view of a coating being applied to a first side of a heat-treated brake rotor;

FIG. 1B is a perspective view of a coating being applied to a second side of a heat-treated brake rotor;

FIG. 2A is a front perspective view of placement of a four-panel box in a four-panel box throwpower test apparatus;

FIG. 2B is a front elevation view of a panel prepared for the four-panel box throwpower test apparatus;

FIGS. 2C and 2D are rear and front perspective views respectively of a four-panel box prepared for the four-panel box throwpower test apparatus;

FIG. 2E is a side elevation view of a partially-assembled four-panel box throwpower test apparatus with a partial section view of four-panel box;

2F is a front elevation view of the anode used in the four-panel box throwpower test apparatus; and

FIG. 2G is a side elevation view of an assembled four-panel box throwpower test apparatus.

FIG. 3 is a graph of throwpowers measured using an assembled four-panel box throwpower test apparatus.

### DETAILED DESCRIPTION

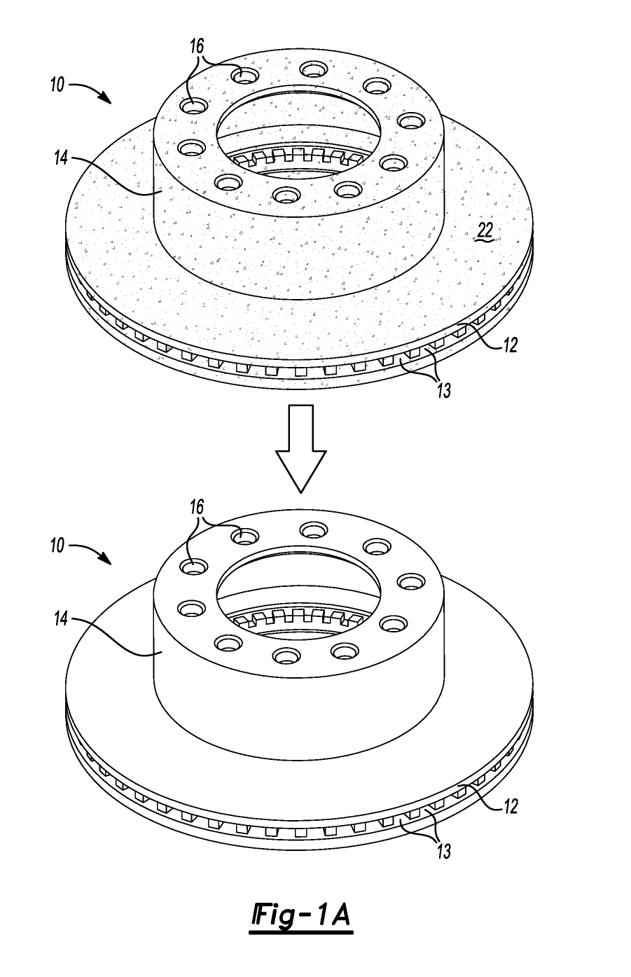

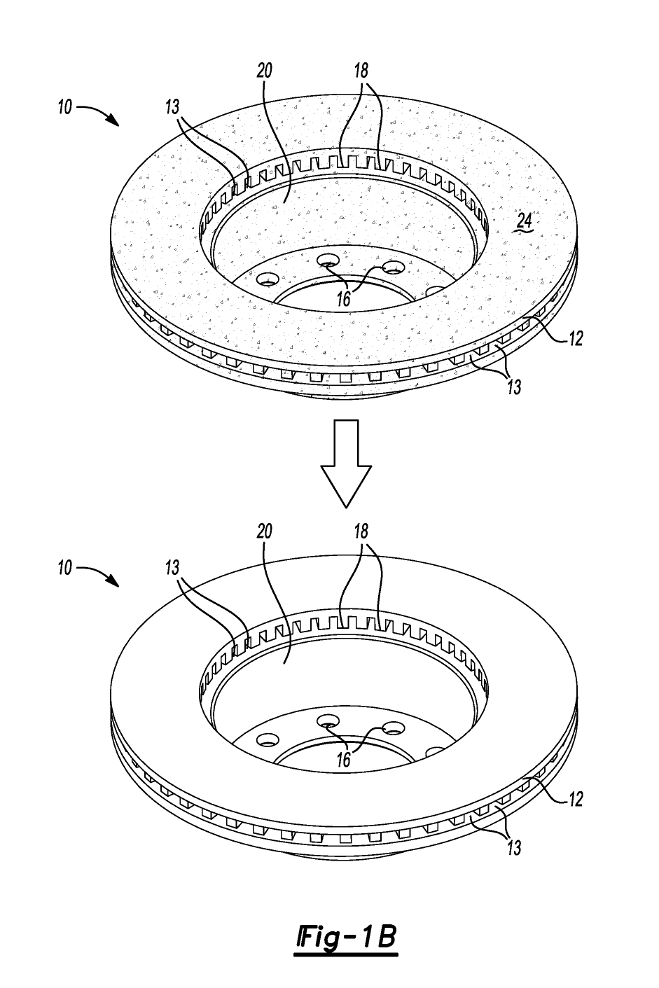

Referring now to the views of FIGS. 1A and 1B, rotor 10 has an outside shown in FIG. 1A and an inside shown in FIG. 1B. Rotor 10 has a disc 12 and top hat 14. Disc 12 includes as cooling elements cooling channels 13 extending through disc 12, with openings on both the outside and inside edges of disc 12. A ring of teeth 18 lie between the inside edge openings of channels 13 and inside surface 20 of top hat 14. Channels 13 aid in cooling rotor 10 of heat generated during braking. Teeth 18 form a unitary part of the rotor and are used primarily as part of the anti-lock braking system to allow a sensor to measure wheel rotation speed, but may also function as cooling fins to help dissipate heat. Rotor 10 is attached to a vehicle hub stator ring (not shown), with disc 12 to the inside and top hat 14 extending outward from the vehicle, by lug studs passing through the holes 16 in top hat 14. During braking of the vehicle, brake pads (not shown) press against outboard braking surface 22 and inboard braking surface 24 of disc 12 to slow and stop the vehicle wheels.

In the disclosed process, rotor 10 first heat-treated to provide a microporous outermost surface layer 25, on which is applied an electrocoat coating layer 26.

Although the example illustration is of a rotor that is separate from and mounted onto a wheel rub, for some vehicles the rotor may be a one-piece construction including a wheel hub component. In addition, although not shown in the illustrated example, the disc may be cross-drilled with cooling holes or vents and the teeth may be absent or differently profiled, sized, or spaced. The rotor may have other or different features or modifications as desired for a particular application.

The rotor is of a ferrous material, typically formed from ductile or gray cast iron. After forming, the ferrous rotor is case hardened using the method disclosed in U.S. Pat. Nos. 5,037,491 and 4,756,774, to produce a characteristic three-layer surface. The case hardening method has steps of placing the rotor into a controlled atmosphere furnace. The controlled atmosphere furnace is maintained at a temperature from about 750° F. (399° C.) to about 1200° F. (649° C.) during the heat treating process. A first gaseous atmosphere selected from ammonia, nitrogen, and natural gas is introduced after temperature equilibration of the rotor in the furnace, and the rotor is treated in the heated atmosphere for about 1 to about 5 hours. Then, the first atmosphere is evacuated and replaced by an atmosphere of nitrogen including from about 10 and about 20 percent by volume nitrous oxide (e.g., medical grade nitrous oxide). The presence of oxygen in the humidified nitrogen atmosphere deepens the oxide outermost surface layer. The rotor is exposed to the nitrous oxide and nitrogen atmosphere for about 30 minutes to about 90 minutes, with the temperature being maintained still at from about 750° F. (399° C.) to about 1200° F. (649° C.).

The case-hardened or heat-treated rotor is characterized in that it has a three-layer surface structure with an outermost microporous layer that is a controlled iron oxide layer, an intermediate layer of a microporous, ferritic nitrocarburized iron epsilon layer, and an innermost nitride layer. The outer iron oxide and intermediate ferritic nitrocarburized iron epsilon layers are chemically bonded and may have porosities of from about 40% to about 60% by volume.

The outermost microporous iron oxide layer, primarily Fe₃O₄, may have a porosity of from about 40% to about 60% and may have pores that may be generally circular, irregularly-shaped openings of from about 2 to about 100 micrometers at their widest diameter. The outermost layer may have a thickness of from about 0.00005 to about 0.0001 inch (about 0.00127 mm to about 0.00254 mm). Underlying the microporous iron oxide layer is a ferritic nitrocarburized iron epsilon layer (or “white layer”) that may also be microporous. The white layer may also have a porosity of from about 40% to about 60%. The white layer may have a thickness of from about 0.0005 to about 0.0015 inch (about 0.0127 mm to about 0.0381 mm). The iron epsilon layer is the equivalent of 58-60 Rockwell “C” and it is defused into the cast iron rotor. Thus, it cannot be removed by the continuous application of the brake pads as an ordinary coating might be. Under the white layer is a third, innermost, nitride layer having nitride needles as a result of nitrogen diffusion into the iron. The third, nitride layer may have a thickness of from about 0.01 to about 0.040 inch (about 0.254 mm to about 1.016 mm). In each case, layer thickness, porosity, and average pore diameter may be measured by electron scanning microscopy or by a microscope equipped with a reticule scale.

The electrocoat coating is applied directed onto the outermost microporous iron oxide layer of the heat-treated rotor. In particular embodiments the rotor is not subject to any phosphating treatment before the electrocoat coating is applied.

The electrocoat coating is applied to the rotor from an aqueous electrocoat coating composition having a binder comprising an acid-salted, amine-functional epoxy resin and a blocked isocyanate crosslinking agent in a cathodic electrocoating process. In the cathodic electrocoating process, the heat-treated rotor is connected as a cathode in a electrical cell having an anode, which may be a post or pole of steel or another metal, and current is passed between the rotor and the anode to electrodeposit a coating layer comprising the amine-functional epoxy resin and blocked isocyanate crosslinker onto the rotor. The electrodeposited coating layer is then cured, such as by the application of heat to the coated rotor.

The amine-functional epoxy resin may be prepared by reaction of a epoxy resin having a plurality of epoxide groups with one or more amine compounds or ketimine compounds. The epoxy resin having a plurality of epoxide groups may be prepared by reaction of a polyepoxide compound with a chain extender (reactant with at least two active hydrogen-containing groups, also referred to as “extender”), and, optionally, one or more monofunctional (chain-stopper) reactants. The chain extender is typically bi-functional, but may be or include (usually in a minor amount) polyfunctional reactants with three or more reactive groups in a ring-opening polymerization (or chain extension). Suitable examples of epoxy resins with a plurality of epoxide groups include diglycidyl aromatic compounds such as the diglycidyl ethers of polyhydric phenols such as 2,2-bis(4-hydroxyphenyl)propane (bisphenol A), 2,2-bis(4-hydroxy-3-methylphenyl)propane, 4,4′-dihydroxybenzophenone, dihydroxyacetophenones, 1,1-bis(4hydroxyphenylene)ethane, bis(4-hydroxyphenyl)methane, 1,1-bis(4hydroxyphenyl)isobutane, 2,2-bis(4-hydroxy-tert-butylphenyl)propane, 1,4-bis(2-hydroxyethyl)piperazine, 2-methyl-1,1-bis(4-hydroxyphenyl)propane, bis-(2-hydroxynaphthyl)methane, 1,5-dihydroxy-3-naphthalene, and other dihydroxynaphthylenes, catechol, resorcinol, and the like, including diglycidyl ethers of bisphenol A and bisphenol A-based resins having a structure

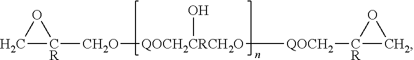

wherein Q is

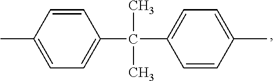

R is H, methyl, or ethyl, and n is an integer from 0 to 10. In certain embodiments, n is an integer from 1 to 5. Also suitable are the diglycidyl ethers of aliphatic diols, including the diglycidyl ethers of 1,4-butanediol, cyclohexanedimethanols, ethylene glycol, propylene glycol, diethylene glycol, dipropylene glycol, triethylene glycol, tripropylene glycol, polypropylene glycol, polyethylene glycol, poly(tetrahydrofuran), 1,3-propanediol, 2,2,4-trimethyl-1,3-pentanediol, 1,6-hexanediol, 2,2-bis(4-hydroxycyclohexyl)propane, and the like. Diglycidyl esters of dicarboxylic acids can also be used as the polyepoxides. Specific examples of compounds include the diglycidyl esters of oxalic acid, cyclohexanediacetic acids, cylcohexanedicarboxylic acids, succinic acid, glutaric acid, phthalic acid, terephthalic acid, isophthalic acid, naphthalene dicarboxylic acids, and the like. A polyglycidyl reactant may be used, preferably in a minor amount in combination with diepoxide reactant. Novolac epoxies may be used as a polyepoxide-functional reactant. The novolac epoxy resin may be selected from epoxy phenol novolac resins or epoxy cresol novolac resins. Other suitable higher-functionality polyepoxides are glycidyl ethers and esters of triols and higher polyols such as the triglycidyl ethers of trimethylolpropane, trimethylolethane, 2,6-bis(hydroxymethyl)-p-cresol, and glycerol; tricarboxylic acids or polycarboxylic acids. Also useful as polyepoxides are epoxidized alkenes such as cyclohexene oxides and epoxidized fatty acids and fatty acid derivatives such as epoxidized soybean oil. Other useful polyepoxides include, without limitation, polyepoxide polymers such as acrylic, polyester, polyether, and epoxy resins and polymers, and epoxy-modified polybutadiene, polyisoprene, acrylobutadiene nitrile copolymer, or other epoxy-modified rubber-based polymers that have a plurality of epoxide groups.

The polyepoxide resin may be reacted with an extender to prepare a polyepoxide resin having a higher molecular weight with beta-hydroxy ester linkages. Suitable, nonlimiting examples of extenders include polycarboxylic acids, polyols, polyphenols, and amines having two or more amino hydrogens, especially dicarboxylic acids, diols, diphenols, and diamines having two secondary amine groups. Particular, nonlimiting examples of suitable extenders include diphenols, diols, and diacids such as those mentioned above in connection with forming the polyepoxide; polycaprolactone diols, and ethoxylated bisphenol A resins such as those available from BASF Corporation under the trademark MACOL®. Other suitable extenders include, without limitation, carboxyl- or amine-functional acrylic, polyester, polyether, and epoxy resins and polymers. Still other suitable extenders include, without limitation, polyamines, including diamines such as ethylenediamine, diethylenetriamine, triethylenetetramine, dimethylaminopropylamine, dimethylaminobutylamine, diethylaminopropylamine, diethylaminobutylamine, dipropylamine, and piperizines such as 1-(2-aminoethyl)piperazine, polyalkylenepolyamines such as triethylenetetramine, tetraethylenepentamine, pentaethylenehexamine, tripropylenetetramine, tetrapropylenepentamine, pentapropylenehexamine, N,N′-bis(3-aminopropyl)ethylenediamine, N-(2-hydroxyethyl)propane-1,3-diamine, and polyoxyalkylene amines such as those available from BASF SE under the trademark POLYAMIN® or from Huntsman under the trademark JEFFAMINE®.

A monofunctional reactant may optionally be reacted with the polyepoxide resin and the extender or after reaction of the polyepoxide with the extender to prepare an epoxide-functional resin. Suitable, nonlimiting examples of monofunctional reactants include phenol, alkylphenols such as nonylphenol and dodecylphenol, other monofunctional, epoxide-reactive compounds such as dimethylethanolamine and monoepoxides such as the glycidyl ether of phenol, the glycidyl ether of nonylphenol, or the glycidyl ether of cresol, and dimer fatty acid.

Useful catalysts for the reaction of the polyepoxide resin with the extender and optional monofunctional reactant include any that activate an oxirane ring, such as tertiary amines or quaternary ammonium salts (e.g., benzyldimethylamine, dimethylaminocyclohexane, triethylamine, N-methylimidazole, tetramethyl ammonium bromide, and tetrabutyl ammonium hydroxide.), tin and/or phosphorous complex salts (e.g., (CH₃)₃SNI, (CH₃)₄PI, triphenylphosphine, ethyltriphenyl phosphonium iodide, tetrabutyl phosphonium iodide) and so on. Tertiary amine catalysts may be preferred with some reactants. The reaction may be carried out at a temperature of from about 100° C. to about 350° C. (in other embodiments 160° C. to 250° C.) in solvent or neat. Suitable solvents include, without limitation, inert organic solvent such as a ketone, including methyl isobutyl ketone and methyl amyl ketone, aromatic solvents such as toluene, xylene, Aromatic 100, and Aromatic 150, and esters, such as butyl acetate, n-propyl acetate, hexyl acetate.

The polyepoxide resin may have an epoxide equivalent weight (EEW) of from about 450 to about 1000 g/eq. In various embodiments, the polyepoxide resin has an EEW of from about 500 to about 850 g/eq or from about 600 to about 700 g/eq.

In an exemplary embodiment, a diglycidyl ether of bisphenol A is reacted with bisphenol A and phenol or the glycidyl ether of phenol in the presence of a suitable catalyst, for example triphenylphosphine, to produce an epoxide-functional resin having an epoxide equivalent weight EEW of about 400 to about 600 g/eq. In various other embodiments the reaction product of epoxide-functional resin may have an EEW of from about 450 to about 575 or from about 500 to about 550.

The polyepoxide resin is reacted with one or more amine compounds or ketimine compounds, generally reacting all of the epoxide groups. Suitable examples of amines that can be used include, without limitation, alkanolamines such as diethanolamine, dipropanolamine, diisopropanolamine, dibutanolamine, diisobutanolamine, diglycolamine, methylethanolamine, dimethylaminopropylamine, dimethylaminopropylamine, N,N-diethylaminopropylamine, dimethylaminoethylamine, N-aminoethylpiperazine, aminopropylmorpholine, tetramethyldipropylenetriamine, methylamine, ethylamine, dimethylamine, dibutylamine, ethylenediamine, diethylenetriamine, triethylenetetramine, dimethylaminobutylamine, diethylaminopropylamine, diethylaminobutylamine, dipropylamine, methylbutylamine , alkanolamines such as methylethanolamine, aminoethylethanolamine, aminopropylmonomethylethanolamine, and diethanolamine, diketimine (a reaction product of 1 mole diethylenetriamine and 2 moles methyl isobutyl ketone), and polyoxyalkylene amines. This reaction may be carried on in a non-reactive solvent, such as any of those mentioned as suitable for preparing the polyepoxide resin. Optionally, solvent and/or unreacted material is removed (e.g., by vacuum distillation) from the product amine-functional epoxy resin.

The amine-functional epoxy resin may have a hydroxyl equivalent weight (HEW) of from about 125 to about 500 g/eq. In various other examples, the amine-functional epoxy resin has a hydroxyl equivalent weight (HEW) of from about 175 to about 325 g/eq, or of from about 225 to about 275 g/eq.

A binder mixture is prepared by combining the amine-functional epoxy resin with a blocked isocyanate crosslinker and optionally other film-forming materials, such as plasticizer, and non-film-forming materials, such as solvents and additives. Examples of aromatic, aliphatic or cycloaliphatic polyisocyanates that may be used to prepare the blocked isocyanate crosslinker include diphenylmethane-4,4′-diisocyanate (MDI), 2,4- or 2,6-tolylene diisocyanate (TDI), p-phenylene diisocyanate, tetramethylene diisocyanate, hexamethylene diisocyanate, dicyclohexylmethane-4,4′-diisocyanate, isophorone diisocyanate, mixtures of phenylmethane-4,4′-diisocyanate, polymethylene polyphenylisocyanate, 2-isocyanatopropylcyclohexyl isocyanate, dicyclohexylmethane 2,4′-diisocyanate, 1,3-bis(iso-cyanatomethyl)cyclohexane, diisocyanates derived from dimer fatty acids, as sold under the commercial designation DDI 1410 by Cognis, 1,8-diisocyanato-4-isocyanatomethyloctane, 1,7-diisocyanato-4-isocyanato-methylheptane or 1-isocyanato-2-(3-isocyanatopropyl)-cyclohexane, and higher polyisocyanates such as triphenylmethane-4,4′,4″-triisocyanate, or mixtures of these polyisocyanates. Suitable polyisocyantes also include polyisocyanates derived from these that containing isocyanurate, biuret, allophanate, iminooxadiazinedione, urethane, urea, or uretdione groups. Polyisocyanates containing urethane groups, for example, are obtained by reacting some of the isocyanate groups with polyols, such as trimethylolpropane, neopentyl glycol, and glycerol, for example. The isocyanate groups of the polyisocyanate are reacted with a blocking agent. Examples of suitable blocking agents include phenol, cresol, xylenol, epsilon-caprolactam, delta-valerolactam, gamma-butyrolactam, diethyl malonate, dimethyl malonate, ethyl acetoacetate, methyl acetoacetate, alcohols such as methanol, ethanol, isopropanol, propanol, isobutanol, tert-butanol, butanol, glycol monoethers such as ethylene or propylene glycol monoethers, acid amides (e.g. acetoanilide), imides (e.g. succinimide), amines (e.g. diphenylamine), imidazole, urea, ethylene urea, 2-oxazolidone, ethylene imine, oximes (e.g. methylethyl ketoxime), and the like.

Catalyst for the curing reaction of a coating film with the binder may be incorporated at this or a later point, such as in a separate catalyst dispersion package or along with a pigment dispersion. Nonlimiting, typical examples are without limitation, tin and bismuth compounds including dibutyltin dilaurate, dibutyltin oxide, and bismuth octoate. When used, catalysts are typically present in amounts of about 0.05 to 2 percent by weight tin based on weight of total resin solids.

The amine groups of the epoxy resin are salted with an acid, nonlimiting, suitable examples of which include phosphoric acid, propionic acid, acetic acid, lactic acid, citric acid, nitric acid, and sulfamic acid in in making an aqueous emulsion or dispersion of the binder mixture. The acid is used in an amount sufficient to neutralize enough of the amine groups of the principal resin to impart water-dispersibility to the resin. The resin may be fully neutralized; however, partial neutralization is usually sufficient to impart the required water-dispersibility. By “partial neutralization” is meant that at least one, but less than all, of the saltable groups on the resin are neutralized. By saying that the resin is at least partially neutralized, it is meant that at least one of the saltable groups on the resin is neutralized, and up to all of such groups may be neutralized. The degree of neutralization that is required to afford the requisite water-dispersibility for a particular resin will depend upon its chemical composition, concentration of amine groups, molecular weight, and other such factors and can readily be determined by one of ordinary skill in the art through straightforward experimentation.

The binder mixture may be emulsified by adding the binder to the water or the water to the binder, and the acid may be mixed with either binder or water. In a further suitable example, a mixture of deionized water and salting acid is fed, along with the binder mixture, into a suitable dispersion vessel to produce an electrocoat emulsion. The amount of electrocoat binder in the dispersion may be from about 10% to about 70% by weight of the emulsion formed. A small amount of higher boiling cosolvents that contribute to coalescence and stability, such as glycol ethers and glycol ether esters, or plasticizer or both may also be included in the electrocoat emulsion. Nonlimiting examples of coalescing solvents include alcohols, glycol ethers, polyols, and ketones. Specific coalescing solvents include monobutyl and monohexyl ethers of ethylene glycol, phenyl ether of propylene glycol, monoalkyl ethers of ethylene glycol such as the monomethyl, monoethyl, monopropyl, and monobutyl ethers of ethylene glycol or propylene glycol; dialkyl ethers of ethylene glycol or propylene glycol such as ethylene glycol dimethyl ether and propylene glycol dimethyl ether; butyl carbitol; diacetone alcohol. Nonlimiting examples of plasticizers include ethylene or propylene oxide adducts of nonyl phenols, bisphenol A, cresol, or other such materials, or polyglycols based on ethylene oxide and/or propylene oxide. The amount of coalescing solvent is not critical and is generally from 0 to 15 percent by weight, preferably from 0.5 to 5 percent by weight, based on total weight of the resin solids in the emulsion. Plasticizers can be used at levels of up to 15 percent by weight resin solids in the emulsion.

The electrocoat emulsion is then used in preparing an electrocoat coating composition (or bath). The electrocoat bath usually includes one or more pigments, separately added as part of a pigment paste, and any further desired materials such as coalescing aids, antifoaming aids, and other additives that may be added before or after emulsifying the resin. Any of the pigments and fillers generally used in electrocoat primers may be included. Extenders such as clay and anti-corrosion pigments are commonly included. Suitable, nonlimiting examples of conventional pigments and fillers for electrocoat primers include titanium dioxide, ferric oxide, carbon black, aluminum silicate, precipitated barium sulfate, aluminum phosphomolybdate, strontium chromate, basic lead silicate or lead chromate. The pigments and fillers may be dispersed using a grind resin (which is generally a binder component) or a pigment dispersant (which may be a binder component). The pigment-to-resin weight ratio in the electrocoat bath can be important and should be preferably less than 50:100, typically less than 40:100, and usually about 10 to 30:100. Higher pigment-to-resin solids weight ratios have been found to adversely affect coalescence and flow. Usually, the pigment is 10-40 percent by weight of the nonvolatile material in the bath. Preferably, the pigment is 15 to 30 percent by weight of the nonvolatile material in the bath.

The electrodeposition coating compositions can contain optional ingredients such as dyes, flow control agents, plasticizers, catalysts, wetting agents, surfactants, UV absorbers, HALS compounds, antioxidants, defoamers and so forth. Examples of surfactants and wetting agents include alkyl imidazolines such as those available from Huntsman as AMINE C® acetylenic alcohols such as those available from Air Products and Chemicals under the tradename SURFYNOL®.

Any of these additional materials may be added at suitable times during making the electrocoat coating composition, e.g. added to the binder mixture, added to the water for making the binder emulsion, added to the binder emulsion, added to the pigment dispersion, or added when preparing the electrocoat coating composition from binder emulsion and pigment dispersion.

The electrocoat coating composition may be prepared by combining the binder emulsion with a pigment dispersion and optionally other materials, such as additional water, additives, cosolvents and so on.

The electrocoat bath generally has an electroconductivity from 800 micromhos to 6000 micromhos. When conductivity is too low, it is difficult to obtain a film of desired thickness and having desired properties. On the other hand, if the composition is too conductive, problems such as the dissolution of substrate or anode in the bath, uneven film thickness, rupturing of the film, or poor resistance of the film to corrosion may result.

The coating composition is electrodeposited onto the rotor and then cured to form a coated rotor. In various embodiments, the electrodeposition coating composition may be applied to a dry film thickness of 10 to 35 μm. After application of the uncured coating layer, the rotor is removed from the bath and rinsed with deionized water. The coating may be cured under appropriate conditions, for example by baking at from about 275° F. to about 375° F. (about 135° C. to about 190° C.) for between about 15 and about 60 minutes.

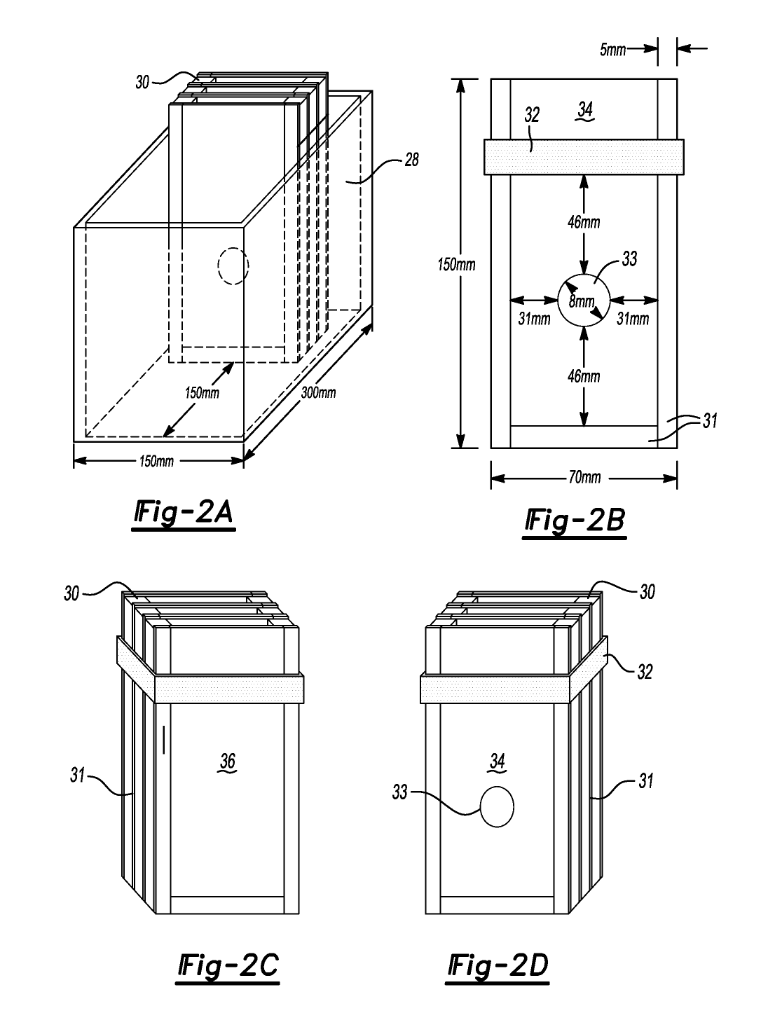

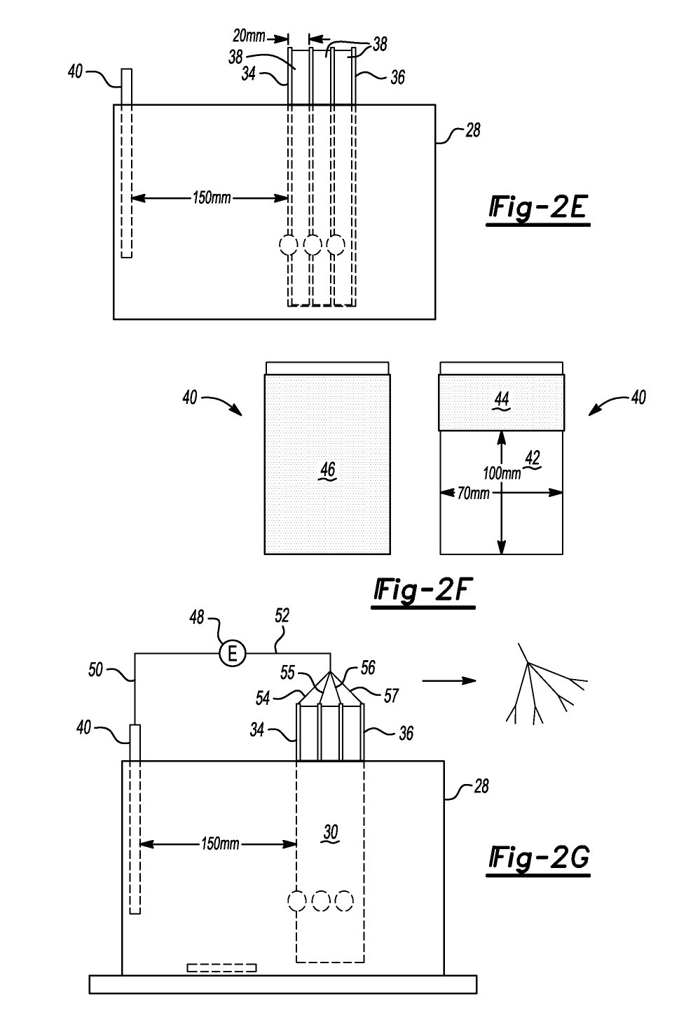

The electrocoat coating composition has a throwpower of at least about 40%, and in certain embodiments at least 50%, as measured by the four-panel box throwpower test method, which will now be described with reference to FIGS. 2A-G. FIG. 2A illustrates a four-panel throwpower box 30 constructed with four steel panels and placed in container 28 of a four-panel box throwpower test apparatus. Container 28 has width 150 mm, length 300 mm, and depth 100 mm. The four-panel throwpower box 30 is place 150 mm from an end of container 28. The four-panel throwpower box 30 has three panels having a hole as shown in FIG. 2B. Panel 35 has dimensions of 150 mm by 70 mm and a front face 34. A hole 33 with an 8 mm diameter is placed 46 mm from a bottom taped edge of panel 35, centered 31 mm from both taped sides. Side and bottom taped edges 31 are taped with electrically insulating tape that 5 mm wide and electrically insulating tape 32 is placed in a band across the panel at a height of 46 mm above hole 33.

With reference to FIGS. 2C-2E, the four-panel throwpower box 30 is assembled using a front, outer panel with surface 34 and hole 33 as shown in FIG. 2B, two center panels prepared in the same way with a hole as shown in FIG. 2B, and a back, outer panel having no hole with outer surface 36, but taped edges 31 taped with electrically insulating tape taped band 32 as are the other three panels and with the same dimensions as in FIG. 2B. The four panels are assembled with magnets 38 separating and holding together the four panels. The magnets 38 provide a separation of 20 mm between each panel and its next neighbor. Magnets 38 are placed even with side and bottom edges and extend 5 mm to the interior of the panels, even with the taped edges. The holes of front panel 34 and the center two panels are aligned. The four-panel throwpower box 30 is placed in container 28 with panel face 34 of the first panel facing anode 40 and 150 mm from anode 40, and panel face 36 of the fourth panel on the end facing away from anode 40. Tape line 32 is along the top edge of container 28. The four-panel throwpower box 30 is electrically sealed along the sides and bottom by the magnets and tape.

FIG. 2F shows the face of anode 40 that faces the four-panel throwpower box 30 is taped with electrically insulating tape in area 44, leaving exposed an area 42 that faces the four-panel throwpower box 30. Anode 40 is entirely taped with electrically insulating tape on its back face 46. FIG. 2G shows the four-panel box throwpower test apparatus connected in an electrical cell, with anode lead wire 50 and cathode lead wire 52 connecting to source 48 of electrical current. Cathode lead wire 52 splits into separate, individual leads 54, 55, 56, 57 to each panel of the four-panel throwpower box 30; front face 34 faces anode 40, back face 36 faces away from anode 40. Magnetic bar 60 and magnetic stirrer 62 agitate the electrocoat coat coating composition in container 28.

To measure throwpower, an electrocoat coating composition is placed in container 28. The electrocoat coating composition is maintained at 35° C. and stirred with magnetic bar 60. Current is provided from source 48 at a voltage that, when provided for 2.2 minutes, will electrodeposit a coating layer about 20 micrometers thick on the panel face (designated side A) closest to anode 40. The panel sides in the thowpower box are designated in this way: panel closest to anode 40, the “first panel,” side toward the anode is side A (this is side 34 in the figures), side away from the anode is side B; panel next to the first panel, “second panel,” side closest to anode 40 is side C, side away from the anode is side D; panel next to the second panel, “third panel,” side closest to anode 40 is side E, side away from the anode is side F; panel furthest from the anode, “fourth panel,” side closest to anode 40 is side G, side away from the anode is side H (this is side 36 in the figures). Throwpower is designated as the percent that the film thickness on side G (fourth panel, side closest to anode) is of the film thickness on side A (first panel, side closest to anode): Throwpower=100×(film thickness of G)/(film thickness of A).

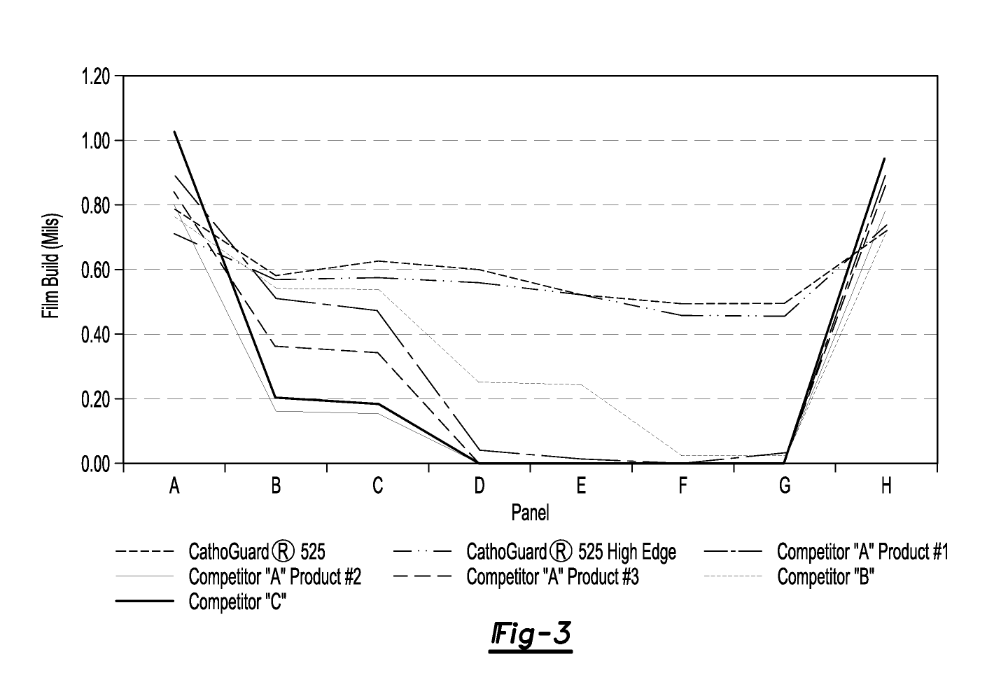

FIG. 3 s a graph of throwpowers measured using an assembled four-panel box throwpower test apparatus. Two electrocoat coating compositions prepared as described, CATHOGUARD® 525 (Example 1) and CATHOGUARD® 525 High Edge (Example 2), both available from BASF Corporation, and five comparative products, P8000 (Comparative Example 3), P6000 (Comparative Example 4), and P590 (Comparative Example 5), each obtained from PPG Industrial Coatings, Cormax VI (Comparative Example 6), obtained from DuPont, and Vectrogard 900 (Comparative Example 7), obtained from Valspar, were tested by placing a four-panel box throwpower box into the container of the test apparatus filled with the electrocoat coating composition being tested. The electrocoat coating composition being tested was at 35° C. The panels of the four-panel box throwpower box are each connected as cathodes, as shown in FIG. 2H and current is passed between anode and cathode for 2.2 minutes. The throwpower box is then removed from the electrocoat coating composition being tested and each of the four panels from the box is rinsed and baked in a 175° C. forced-air oven for 28 minutes. The filmbuilds on each side of the throwbox panels are shown in FIG. 3. As shown in FIG. 3, only the electrocoat coating compositions prepared as described in this disclosure provide a measurable filmbuild on side G. The filmbuilds for each electrocoat coating composition are shown in the following table.

Throwpower Box Filmbuild Data

| | Panel Side | | | | | | | |
|---|---|---|---|---|---|---|---|---|
| Electrocoat Technology | A | B | C | D | E | F | G | H |
| Ex. 1 - CathoGuard ® 525 | 0.79 | 0.58 | 0.62 | 0.60 | 0.52 | 0.49 | 0.49 | 0.72 |
| Ex. 2 - CathoGuard ® 525 High | 0.71 | 0.57 | 0.57 | 0.56 | 0.52 | 0.45 | 0.45 | 0.74 |
| Edge | | | | | | | | |
| Comparative Ex. 6 - DuPont | 0.76 | 0.54 | 0.54 | 0.25 | 0.24 | 0.02 | 0.02 | 0.72 |
| Coremax VI - PCII | | | | | | | | |
| Comparative Ex. 3 - PPG PC8000 - | 0.89 | 0.51 | 0.47 | 0.04 | 0.01 | 0.00 | 0.03 | 0.89 |
| Intex #1 | | | | | | | | |
| Comparative Ex. 4 - PPG | 0.80 | 0.16 | 0.15 | 0.00 | 0.00 | 0.00 | 0.00 | 0.78 |
| PC6000CX - Woodard | | | | | | | | |
| Comparative Ex. 5 - PPG PC590 - | 0.84 | 0.36 | 0.34 | 0.00 | 0.00 | 0.00 | 0.00 | 0.86 |
| Spectrum | | | | | | | | |
| Comparative Ex. 7 - Valspar | 1.02 | 0.20 | 0.18 | 0.00 | 0.00 | 0.00 | 0.00 | 0.94 |
| VG900 - Unicote | | | | | | | | |

Examples 1 and 2, CATHOGUARD® 525 and CATHOGUARD® 525 High Edge, have high throwpowers of 62 and 63.4 and thus can provide the protection to the rotor as disclosed. Comparative Examples 3-7 do not have adequate throwpower to protect the rotor from corrosion and lot rot: their throwpowers are Comparative Example 6, 2.6; Comparative Example 3, 3.4; Comparative Example 4, 0; Comparative Example 5, 0; and Comparative Example 7, 0.

Two rotors are heat treated to provide a surface having a three-layer structure as described above of a microporous outermost surface layer of a controlled iron oxide, an intermediate surface layer of a microporous, ferritic nitrocarburized iron epsilon, and an innermost nitride layer. The outermost surface layer and intermediate surface layer each have porosities of from about 40% to about 60% by volume. Then, one rotor is coated with an electrodeposited layer of CATHOGUARD® 525 and the other rotor is coated with an electrodeposited layer of CATHOGUARD® 525 High Edge. The electrocoat layers are cured, and the heat-treated and coated rotors are resistant to corrosion and lot rot.

It should be understood that the description and specific examples are intended for purposes of illustration only and are not intended to limit the scope of the present disclosure. The description is merely exemplary in nature and, thus, variations that do not depart from the gist of the disclosure are a part of the invention. Variations are not to be regarded as a departure from the spirit and scope of the disclosure.

1. A method of treating a rotor, comprising:
heat-treating the surface of a ferrous rotor having cooling elements to provide a microporous, outermost surface layer;
electrodepositing a coating layer of an electrocoat coating directed on the surface of the heat-treated rotor, wherein the electrocoat coating layer has a throwpower of at least about 40% and the wherein the coating layer is continuous on cooling elements of the rotor.

2. The method according to claim 1, wherein the microporous, outermost surface layer is a controlled iron oxide layer.

3. The method according to claim 1, wherein the microporous, outermost surface layer overlies a microporous, ferritic nitrocarburized iron epsilon layer.

4. The method according to claim 3, wherein the microporous, ferritic nitrocarburized iron epsilon layer overlies a nitride layer.

5. The method according to claim 3, wherein the microporous, outermost surface layer and the ferritic nitrocarburized iron epsilon layer are chemically bonded and the microporous, outermost surface layer has a porosity of from about 40% to about 60% by volume.

6. The method according to claim 1, wherein the microporous, outermost surface layer has a thickness of from about 0.00005 to about 0.0001 inch (about 0.00127 mm to about 0.00254 mm).

7. The method according to claim 1, wherein the microporous, outermost surface layer has generally circular, irregularly-shaped pores of from about 2 to about 100 micrometers at their widest diameter.

8. A rotor produced according to the method of claim 1.

9. A method of treating a rotor, comprising:
heat-treating the surface of a ferrous rotor having cooling elements to provide a microporous, outermost surface layer;
electrodepositing a coating layer of an electrocoat coating directed on the surface of the heat-treated rotor, wherein the electrocoat coating layer is electrodeposited from an electrocoat coating composition comprising a binder comprising an amine-functional epoxy resin that is the reaction product of a polyepoxide having an epoxide equivalent weight of from about 450 to about 1000 grams/equivalent and an amine having at least one group reactive with an epoxide group, wherein the amine groups of the amine-functional epoxy resin are neutralized with an acid to an extent such that the amine-functional epoxy resin is made water-dispersible.

10. The method according to claim 9, wherein the microporous, outermost surface layer is a controlled iron oxide layer.

11. The method according to claim 10, wherein the microporous, outermost surface layer overlies a microporous, ferritic nitrocarburized iron epsilon layer.

12. The method according to claim 11, wherein the microporous, ferritic nitrocarburized iron epsilon layer overlies a nitride layer.

13. The method according to claim 11, wherein the microporous, outermost surface layer and the ferritic nitrocarburized iron epsilon layer are chemically bonded and the microporous, outermost surface layer has a porosity of from about 40% to about 60% by volume.

14. The method according to claim 9, wherein the microporous, outermost surface layer has generally circular, irregularly-shaped pores of from about 2 to about 100 micrometers at their widest diameter.

15. The method according to claim 9, wherein the microporous, outermost surface layer has a thickness of from about 0.00005 to about 0.0001 inch (about 0.00127 mm to about 0.00254 mm).

16. A rotor produced according to the method of claim 9.
